(19) United States
(12) Patent Application Publication
(10) Pub. No.: US 2009/0033934 A1
(43) Pub. Date: Feb. 5, 2009

(54) DROPLET FORMATION APPARATUS AND METHODS FOR FORMING DROPLET AND CALIBRATING PARTICLE SIZE MEASUREMENT APPARATUS

(75) Inventors: Hidetoshi Katou, Komaki-city (JP); Makoto Yamaguchi, Kariya-city (JP); Yoshinori Yamashita, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/166,747

(22) Filed: Jul. 2, 2008

(30) Foreign Application Priority Data
Aug. 2, 2007 (JP) 2007-202137

(51) Int. Cl. G01N 15/02

(52) U.S. Cl. 356/336

(57) ABSTRACT

A droplet formation apparatus is provided for calibrating a particle size measurement apparatus. A vessel stores sample liquid. A pressure unit applies predetermined pressure to the sample liquid in the vessel. An oscillator is provided to one surface of the vessel for applying oscillation, which has a predetermined frequency, to the sample liquid in the vessel. An orifice is provided to an other surface of the vessel. The orifice has at least one discharge hole. The orifice is configured to form a droplet, which has a predetermined particle size, from the sample liquid and configured to discharge the droplet in accordance with the predetermined pressure and the predetermined frequency applied to the sample liquid in the vessel.

### CROSS REFERENCE TO RELATED APPLICATIONS

This application is based on and incorporates herein by reference Japanese Patent Application No. 2007-202137 filed on Aug. 2, 2007.

### FIELD OF THE INVENTION

The present invention relates to a droplet formation apparatus for calibrating a particle size measurement apparatus. The invention further relates to a method for forming a droplet. The invention further relates to a method for calibrating a particle size measurement apparatus.

### BACKGROUND OF THE INVENTION

Conventionally, a particle size measurement apparatus is configured to, for example, irradiate laser light to a particle being an object sample to be measured, thereby measuring a distribution in intensity of diffracted light or scattered light of the laser light. Thus, the particle size measurement apparatus measures the particle size or distribution in particle size of the object sample. Such a particle size measurement apparatus is calibrated by using a master particle, which has a known particle size, in order to accurately measure the particle size of the object sample. For example, JP-A-2001-165846 discloses a calibration standard sample sheet, which is a transparent member such as glass sheet therein containing master particles of powder each formed in a spherical shape and having a known diameter.

However, the material of the object sample to be measured may be different from the material of the master particles contained in the calibration standard sample sheet. In this case, the physical properties are different therebetween. Specifically, the refractivity or the transmittance is different therebetween when being irradiated with laser light. More specifically, when the object sample to be measured is irradiated with laser light, distribution in intensity of the diffracted light or the scattered light from the object sample is different from the case where the calibration standard sample sheet is irradiated with laser light. Consequently, when the particle size of the object sample is measured by using a particle size measurement apparatus, which is calibrated with the calibration standard sample sheet, the particle size may not be accurately obtained. Therefore, the obtained particle size need to be corrected in consideration of difference in physical property between the object sample and the master sample, in order to obtain accurate particle size of the object sample. Therefore, a correction factor used for such correction needed to be separately obtained. In particular, when the object sample to be measured includes a liquid, the correction is definitely needed, since it is hard to prepare a calibration standard sample sheet, which contains a relevant sample.

### SUMMARY OF THE INVENTION

In view of the foregoing and other problems, it is an object of the present invention to produce a droplet formation apparatus, which is configured to form a droplet having a desired particle size. It is another object of the present invention to produce a method for forming a droplet, which has a desired particle size, for calibrating a particle size measurement apparatus. It is another object of the present invention to produce a method for calibrating the particle size measurement apparatus.

According to one aspect of the present invention, a droplet formation apparatus for calibrating a particle size measurement apparatus, the droplet formation apparatus comprise a vessel for storing sample liquid. The droplet formation apparatus further comprises a pressure unit for applying predetermined pressure to the sample liquid in the vessel. The droplet formation apparatus further comprises an oscillator provided to one surface of the vessel for applying oscillation, which has a predetermined frequency, to the sample liquid in the vessel. The droplet formation apparatus further comprises an orifice provided to an other surface of the vessel. The orifice has at least one discharge hole. The orifice is configured to form a droplet, which has a predetermined particle size, from the sample liquid and configured to discharge the droplet in accordance with the predetermined pressure and the predetermined frequency applied to the sample liquid in the vessel.

According to another aspect of the present invention, a method for forming a droplet, which is for calibrating a particle size measurement apparatus, the method comprises applying predetermined pressure to sample liquid stored in a vessel. The method further comprises applying oscillation, which has a predetermined frequency, to the sample liquid stored in the vessel so as to form a droplet, which has a predetermined particle size, from the sample liquid and discharge the droplet through a discharge hole, which is provided in one surface of the vessel.

According to another aspect of the present invention, a method for calibrating a particle size measurement apparatus, the method comprises applying predetermined pressure to sample liquid stored in a vessel. The method further comprises applying oscillation, which has a predetermined frequency, to the sample liquid stored in the vessel so as to form a droplet, which has a predetermined particle size, from the sample liquid and discharge the droplet through a discharge hole, which is provided in one surface of the vessel. The method further comprises measuring the particle size of the droplet of the sample liquid by using the particle size measurement apparatus. The method further comprises calibrating the particle size measurement apparatus such that the particle size, which is measured by using the particle size measurement apparatus, corresponds to the predetermined particle size.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic block diagram showing a droplet formation apparatus for calibrating a particle size measurement apparatus, according to an embodiment of the invention;

FIG. 2 is an exploded lateral sectional view showing a master vessel of the droplet formation apparatus;

FIG. 3 is a schematic lateral sectional view showing an orifice of the droplet formation apparatus;

FIG. 4 is a graph showing a relationship between a ratio of a channel length L to a diameter D of a discharge hole and pressure P₂ and indicating a simulation result of a condition for forming a droplet;

FIG. 5 is a schematic lateral sectional view showing an orifice according to a comparative example;

FIG. 6 is a flowchart showing a procedure for forming droplets by using the droplet formation apparatus;

FIG. 7 is a graph showing a relationship between a particle size of each droplet formed by using the droplet formation apparatus and a particle size; and

FIGS. 8A to 8E are photographs showing the droplets formed by using the droplet formation apparatus.

### DETAILED DESCRIPTION OF PREFERRED EMBODIMENTS

### Embodiment

Hereinafter, a droplet formation apparatus for calibrating a particle size measurement apparatus will be described in detail with reference to drawings. In such a droplet formation apparatus, liquid is filled in a vessel having an orifice. The orifice has a discharge hole having a small diameter. The orifice is applied with constant pressure and oscillation having a constant frequency. Thus, a droplet having a predetermined particle size is discharged from the discharge hole.

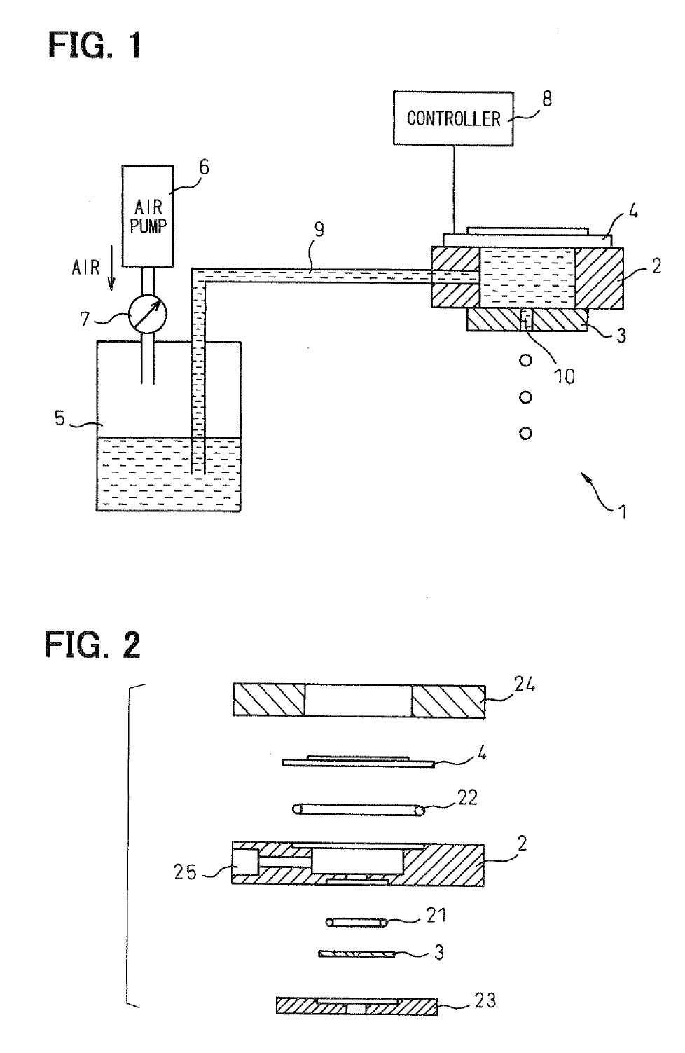

As shown in FIG. 1, a droplet formation apparatus 1, which is for calibrating a particle size measurement apparatus, has a master vessel 2, an orifice 3, an oscillator 4, a pressure vessel 5, an air pump 6, a pressure-regulating valve 7, and a controller 8.

The master vessel 2 stores sample liquid. The sample liquid includes, for example, the same material as that of a sample measured by the particle size measurement apparatus. The inside of the master vessel 2 is filled with the sample liquid. As shown in FIGS. 1, 2, the orifice 3 is provided on the bottom of the master vessel 2. The orifice 3 has a discharge hole 10 for discharging a droplet therethrough. Furthermore, the oscillator 4 is provided on the top of the master vessel 2. The oscillator 4 is provided on the opposite side of the orifice 3. The orifice 3 and the oscillator 4 may be respectively provided on the lateral sides of the master vessel 2.

An O ring 21 as a sealing member is provided between the orifice 3 and the master vessel 2 so as to restrict leakage of the sample liquid from the inside of the master vessel 2. Similarly, an O ring 22 is provided between the oscillator 4 and the master vessel 2. Furthermore, the orifice 3 and the oscillator 4 are fixed to the master vessel 2 by fixing tools 23, 24.

The inside of the master vessel 2 is in an approximately cylindrical shape. In the present structure of the master vessel 2, a pressure wave, which is caused by the oscillation from the oscillator 4, is irregularly reflected by the inner wall of the master vessel 2. Thus, the pressure wave is superposed on one another, and hence the oscillation frequency varies near the discharge hole 10. Consequently, the particle size of the formed droplet can be restricted from being irregularly changed. The master vessel 2 has a supply port 25 in one lateral side for supplying the sample liquid into the master vessel 2. The supply port 25 is connected with a pipeline 9. The master vessel 2 is connected to the pressure vessel 5 through the pipeline 9. The sample liquid in the master vessel 2 can be applied with desired pressure using the air pump 6, which is provided to the pressure vessel 5. More specifically, the pressure-regulating valve 7 is provided between the air pump and 6 and the pressure vessel 5. The pressure-regulating valve 7 regulates the amount of air supplied from the air pump 6, so that the inside of the pressure vessel 5 is set at predetermined pressure. Since various devices including a known component may be used for the air pump 6 and the pressure-regulating valve 7, detailed description of the air pump 6 and the pressure-regulating valve 7 is omitted here.

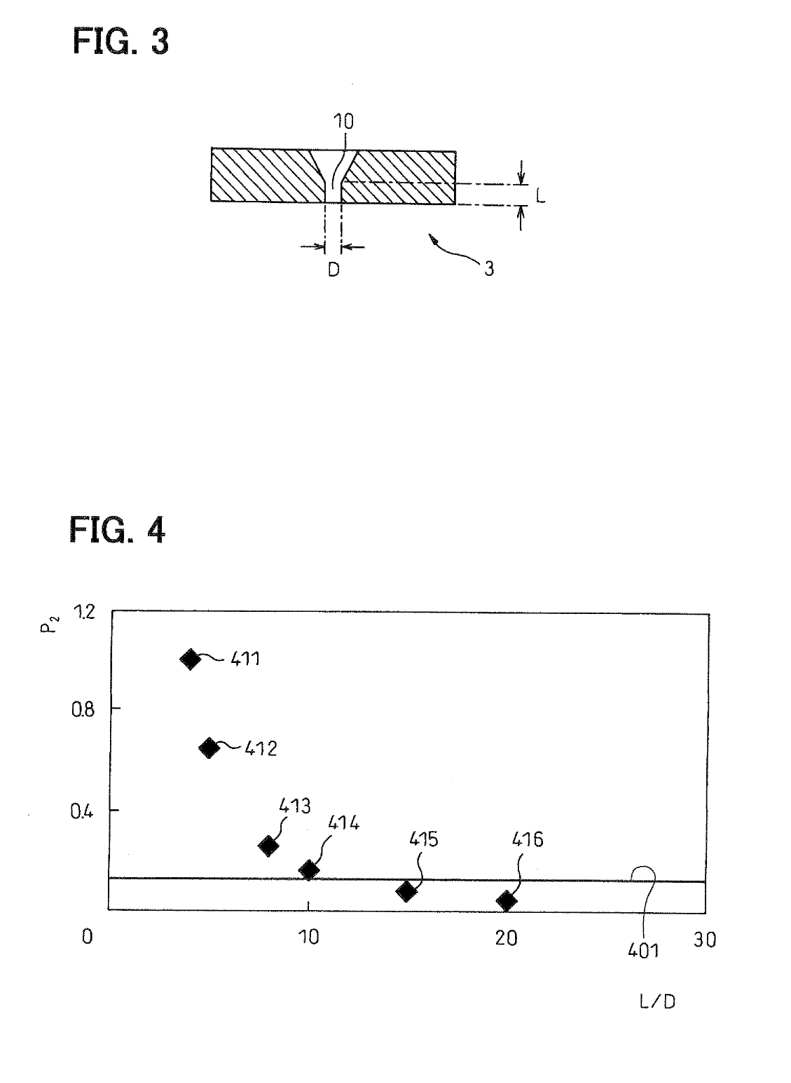

The orifice 3 is configured to form the sample liquid filled in the master vessel 2 into droplets, thereby to discharge the droplets. As shown in FIG. 3, the discharge hole 10 being in a funnel shape is formed in an approximate center of the orifice 3. The discharge hole 10 may be in a columnar shape. For example, the discharge hole 10 may be in a cylindrical shape or a square-poll shape. Here, it is known that the particle size of a droplet to be formed is at least 1.9 times as large as the diameter D at the lower end of the discharge hole 10. Thus, the diameter D of the discharge hole 10 is set in a value being not more than half the value of the particle size of the droplet to be formed.

The following documents may be referred on a relationship between the particle size of a droplet and the diameter of a discharge hole.
Kou Imai and Hidenori Hashimoto: Lamb, Hydrodynamics, Tokyo Tosho Co., Ltd. (1981) PP. 249-254.
Ichiro Tani: Progress of Hydrodynamics, Turbulence, Maruzen Company, Limited (1980) PP. 177-219.
“Hydrodynamics, Stability and Turbulence”, University of Tokyo Press, PP. 54-57.

The channel length L of the discharge hole 10 is preferably not more than approximately ten times as large as the diameter D of the discharge hole 10. The channel length L is designed to be short in this way, thereby the sample liquid is smoothly discharged from the discharge hole 10, and therefore the droplet can be easily formed. Furthermore, the ratio L/D of the channel length L to the diameter D is further reduced, thereby the sample liquid to be discharged from the discharge hole 10 can be restricted from being diffused, and therefore a droplet having a desired particle size can be easily formed.

Here, how the droplet to be formed is changed depending on the ratio L/D is simulated by changing the ratio L/D of the channel length L to the diameter D. A result of the simulation is shown as follows. Generally, when the sample liquid is discharged from the orifice, a liquid film of the sample liquid is formed so as to cover the outlet of the discharge hole of the orifice. Therefore, when low pressure is applied to the sample liquid, the sample liquid is substantially not discharged, since surface tension is caused by the liquid film. Consequently, a droplet is hard to be formed. Thus, in the simulation, it is assumed that a droplet is formed in a condition where the sample liquid is discharged from the discharge hole 10. That is, it is assumed that a droplet is formed in a condition where the force, which is applied to the sample liquid from the inside of the master vessel 2 at the outlet of the discharge hole 10, is larger than the surface tension caused by the liquid film of the sample liquid formed at the outlet of the discharge hole 10.

Here, a discharge flow rate of the sample liquid discharged from the discharge hole 10 can be expressed by the following expression;

$$Q = \frac{{P}_{1} π {D}^{4}}{108 µ π L} , \qquad ( 1 )$$

wherein Q shows the discharge flow rate, P₁ shows the pressure applied to the sample liquid through the pressure vessel 5, D shows the diameter of the discharge hole 10, L shows the channel length of the discharge hole 10, and μ shows the viscosity coefficient of the sample liquid.

On the other hand, the discharge flow rate Q, and the discharge pressure P₂ applied to the sample liquid at the outlet of the discharge hole 10 are expressed by the following relational expression;

$$Q = \frac{π {cD}^{2}}{4} \sqrt{\frac{2 {P}_{2}}{ρ}} , \qquad ( 2 )$$

wherein ρ shows the density of the sample liquid, and c shows the flow rate coefficient.

Moreover, as described before, the condition where the sample liquid is discharged from the discharge hole 10 is that the force, which is applied to the sample liquid from the inside of the master vessel 2 at the outlet of the discharge hole 10, is larger than the surface tension caused by the liquid film of the sample liquid formed at the outlet of the discharge hole 10. Therefore, the condition can be expressed by the following expression;

P₂πD²/4≧TπD (3),

wherein T shows the surface tension caused by the liquid film of the sample liquid.

FIG. 4 shows a result of the simulation on the basis of the expressions (1) to (3) when the ratio L/D is changed at the following condition. The horizontal axis in FIG. 4 shows the ratio L/D, and the vertical axis in FIG. 4 shows the discharge pressure P₂. Each of points 411 to 416 shows a calculation result of the discharge pressure P₂ when the ratio L/D is changed. In the simulation, a dry solvent is assumed to be used as the sample liquid. The dry solvent has the density ρ of 0.79 g/cm³, the viscosity coefficient μ of 0.00091 Pa·s, and the surface tension of 24.8 dyn/cm. In the simulation, it is further assumed that the supply pressure P₁ is 100 kPa and the flow rate coefficient c is 0.7. At that time, the minimum value of the discharge pressure P₂, which satisfies the expression (3), is a value corresponding to a horizontal line 401 on the graph in FIG. 4. It is obvious from the graph that when the ratio L/D is approximately 10 or less, the discharge pressure P₂ is more than the value corresponding to the horizontal line 401. Consequently, the ratio L/D of the channel length L of the discharge hole 10 to the diameter D needs to be 10 or less.

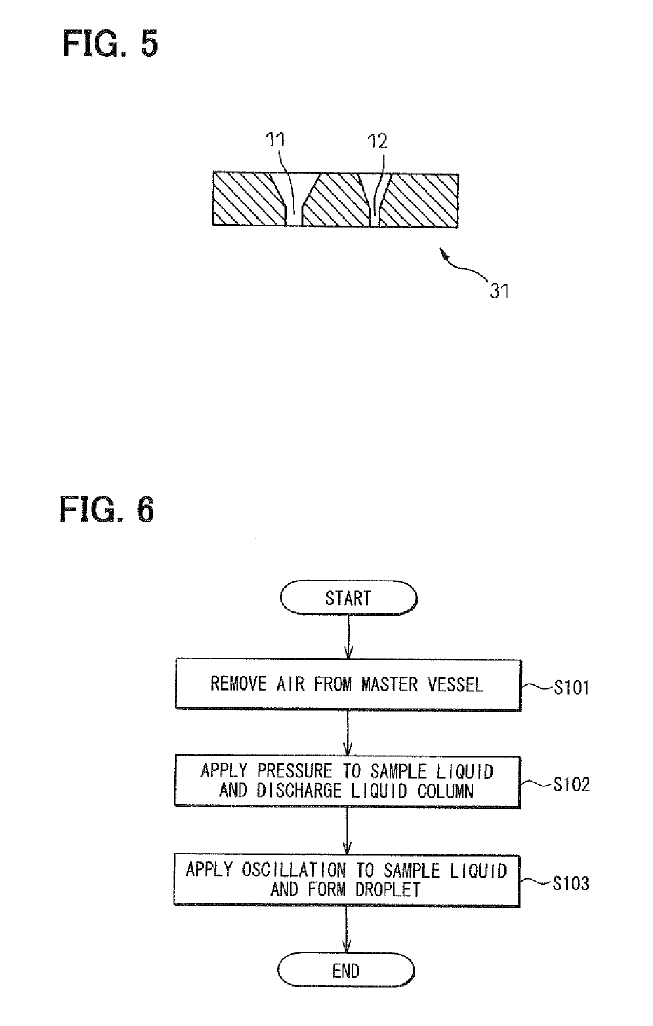

FIG. 5 shows a schematic lateral sectional view of an orifice 31 according to a comparative example. As shown in FIG. 5, the orifice 31 has multiple discharge holes 11, 12. The multiple discharge holes 11, 12 are different in diameter from each other. In the present structure, the multiple discharge holes are formed thereby the number of droplets formed at the same time can be increased in the droplet formation apparatus 1. Therefore, it is possible to form a master of a droplet, which is more similar to a droplet given at a measurement condition when the particle size is actually measured by an particle size measurement apparatus (not shown). In particular, the orifice has discharge holes being different in diameter from each other, thereby a particle size distribution can be given in droplets to be formed. Consequently, the particle size measurement apparatus can be calibrated for various kinds of particle size. The number of the discharge holes formed in an orifice is not limited to one or two, but may be three or more. Furthermore, to change particle size of a droplet to be formed, multiple orifices may be prepared. In this case, each of the orifices is different in diameter of a discharge hole 10, and the master vessel 2 may be designed to have an orifice 3 being changeable.

The oscillator 4 applies oscillation having a predetermined frequency to the sample liquid in the master vessel 2. The sample liquid is applied with the oscillation from the oscillator 4, thereby the sample liquid discharged from the discharge hole 10 can be formed into a droplet. As well known, the particle size of a droplet is determined by the diameter of the discharge hole 10, the pressure, and oscillation frequency applied to the sample liquid. Thus, the oscillator 4 is preferably variable in oscillation frequency thereof, so that droplets having various kinds of particle size can be supplied. In the present embodiment, for example, the oscillator 4 is configured by a piezoelectric oscillator. The oscillator 4 may be configured using each of various other oscillators such as an acoustic oscillator.

The oscillator 4 applies oscillation to the sample liquid in the master vessel 2 at a predetermined frequency perpendicularly to the liquid surface of the sample liquid. In addition, the oscillator 4 applies oscillation to the sample liquid in a direction approximately in parallel to the channel of the discharge hole 10 of the orifice 3. In the present structure, the oscillator 4 is provided oppositely to the orifice 3 in this way. Whereby, the pressure wave caused by the oscillation applied by the oscillator 4 is reflected by the lateral side of the master vessel 2, and thus applied to the sample liquid in a superposed manner, so that the particle size of a droplet can be restricted from irregularly varying.

The controller 8 is configured by, for example, a personal computer (PC) having an arithmetic unit, a storage, peripheral devices such as a display, and a keyboard. The PC has a computer program running thereon. The controller 8 is electrically connected to the oscillator 4, thereby controlling the oscillator 4 to generate oscillation having a desired frequency. The controller 8 may be used as a controller for controlling the air pump 6 and the pressure-regulating valve 7.

A procedure of a droplet formation using the droplet formation apparatus 1 will be described with reference to FIG. 6. First, as advance preparations, the orifice 3 having the discharge hole 10 is attached to the master vessel 2. The discharge hole has an appropriate diameter with respect to a target particle size of a droplet to be intentionally formed. As described before, the particle size of the droplet to be formed is at least 1.9 times as large as the diameter of the discharge hole 10. Therefore, for example, when the target particle size of the droplet to be intentionally formed is 100 μm, an orifice 3, which has the discharge hole 10 being 50 μm or less in diameter is attached to the master vessel 2. When droplets having different kinds of particle size are desirably formed at the same time so as to cause the droplets to have distribution in particle size, the orifice 31 (FIG. 5) may be attached to the master vessel 2, which has the multiple discharge holes 11, 12 being different in diameter from each other.

At step S101, the sample liquid is supplied from the pressure vessel 5 into the master vessel 2 of the droplet formation apparatus 1. Whereby, the sample liquid is applied with specific pressure for removing air in order to restrict entrapped air from being left within the master vessel 2. Next, at step S102, the pressure-regulating valve 7 is controlled to increase the pressure applied to the sample liquid until a liquid column is discharged from the discharge hole 10 of the orifice 3. Then, at step S103, the controller 8 outputs a control signal to the oscillator 4 so as to generate the oscillation having a predetermined frequency in order to separate the liquid column, which is discharged from the discharge hole 10, into droplets. When the oscillator 4 is oscillated, such oscillation is transferred to the liquid column through the sample liquid in the master vessel 2. Thus, a surface wave is formed on the surface of the liquid column. When the amplitude of the surface wave becomes equal to the diameter of the liquid column, the liquid column is divided. The divided portion of the liquid column is formed into a spherical shape by being applied with the surface tension, and consequently a droplet is formed.

As described before, the particle size of the formed droplet is determined by the diameter of the discharge port 10, the pressure applied to the sample liquid, and the oscillation frequency applied to the sample liquid. The relationship among the particle size, the diameter of the discharge port 10, the pressure, and the oscillation frequency is known. Thus, the pressure-regulating valve 7 is controlled to set the pressure applied to the sample liquid in the master vessel 2 to be in a desired value, and the frequency of the oscillation generated by the oscillator 4 is adjusted, thereby a droplet having the desired particle size can be formed by the droplet formation apparatus 1. For example, in the droplet formation apparatus 1, as the desired particle size of a droplet is smaller, the frequency of the oscillation generated by the oscillator 4 is set higher.

As described hereinbefore, in the droplet formation apparatus 1 according to the present embodiment, the diameter of the discharge port 10, the pressure applied to the sample liquid, and the oscillation frequency applied to the sample liquid are appropriately adjusted. Whereby, the droplet of the same material as that of a sample, which is to be measured by an particle size measurement apparatus, can be provided to have a desired particle size. Therefore, the particle size measurement apparatus can be easily calibrated. In addition, a correction of the particle size measurement apparatus can be omitted when the particle size of a droplet is measured using the particle size measurement apparatus. For example, a droplet having a desired particle size, which is formed by the droplet formation apparatus 1, is provided as a standard particle to the particle size measurement apparatus. For example, as disclosed in U.S. Pat. No. 7,084,975 B2 (JP-A-2003-149123), the particle size measurement apparatus includes a light source, a detector, and an arithmetic unit. The light source irradiates laser light to an object sample to be measured. The detector detects light scattered or diffracted by the object sample. The arithmetic unit obtains the particle size of the object sample to be measured based on the detected light. The particle size measurement apparatus is calibrated such that the particle size obtained by measuring the provided droplet corresponds to the particle size of the sample droplet.

Hereinafter, a result of an experiment where a calibration droplet is formed using the droplet formation apparatus 1 will be described.

Experiment 1

In the experiment 1, an orifice having a single discharge hole is used to form a droplet having a single particle size. A dry solvent is used as a sample liquid. In addition, six types of orifices were prepared, of which the discharge holes are different in diameter from one another. The orifices respectively have the discharge holes 10, 20, 30, 50, 80, and 100 μm in diameter. Pressure in the master vessel 2 is set to be 20 kPa or 40 kPa. The oscillator 4 is oscillated at the oscillation frequency of 1 kHz to 12 kHz to discharge droplets.

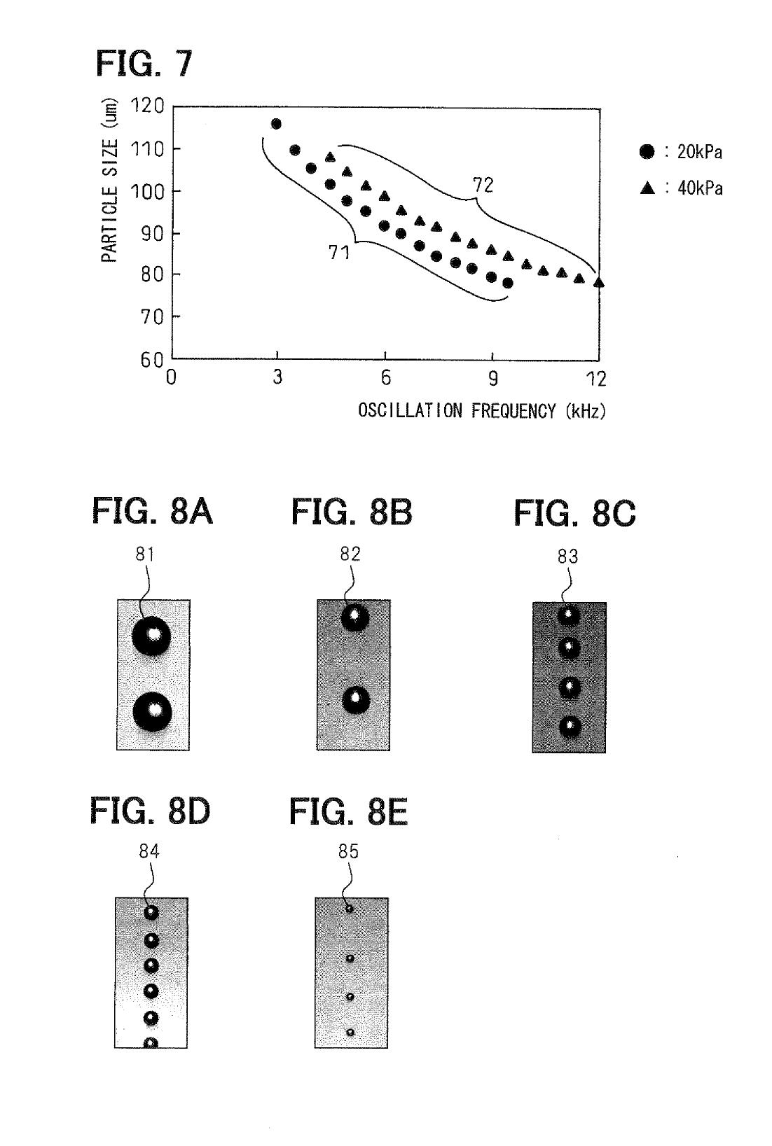

The graph in FIG. 7 shows a relationship between the pressure and the oscillation frequency applied to the sample liquid, and the particle size of each of the formed droplets in the case of using the orifice having a discharge hole 80 μm in diameter. In FIG. 7, the horizontal axis shows the oscillation frequency, and the vertical axis shows the particle size of each of the formed droplets. A group 71 of the measured points each depicted by the circle shows the particle size of each droplet when the pressure is set to 20 kPa. On the other hand, a group 72 the measured points each depicted by the triangle shows the particle size of each droplet when the pressure is set to 40 kPa. As shown in FIG. 7, the pressure and the oscillation frequency in the master vessel are adjusted as above, thereby the droplets, each having the uniform size of 78 μm to 116 μm in diameter, are able to be formed by the droplet formation apparatus 1. Similarly, the orifice is changed, and the pressure and the oscillation frequency in the master vessel are appropriately adjusted, thereby the droplets, each having the uniform size of 20 μm to 200 μm in diameter, are able to be formed.

FIGS. 8A to 8E show photographs depicting the droplets formed using the droplet formation apparatus 1. Droplets 81 to 85 shown in FIGS. 8A to 8E respectively correspond to 146 μm, 105 μm, 75 μm, 62 μm, and 40 μm in particle size. According to FIGS. 8A to 8E, the droplets are successively formed, and each droplet in each particle size has a uniform diameter.

Experiment 2

In the experiment 2, an orifice having two discharge holes, which are different in diameter from each other, is used to form two droplets different in particle size from each other at the same time. Dry solvent is used as the sample liquid. In addition, the master vessel is attached with an orifice, which have a discharge hole 30 μm in diameter and a discharge hole 40 μm in diameter. Pressure in the master vessel 2 is set to be 120 kPa, The oscillator 4 is oscillated at the oscillation frequency of 12 kHz to discharge droplets. As a result, droplets, each having the uniform diameter of 70 μm, and droplets, each having the uniform diameter of 80 μm, are able to be formed by the droplet formation apparatus 1.

The invention is not limited to the above embodiments. For example, the droplet formation apparatus 1 may further have a high-speed camera, which is capable of photographing images of 1000 frames/sec, for example, such that each image of the formed droplet taken by the high-speed camera is analyzed by the controller 8 to determine particle size of the formed droplet. Furthermore, the controller 8 may adjust or regulate the oscillator 4 or the pressure-regulating valve 7 based on the determined particle size of the droplet to correct the pressure the oscillation frequency applied to the sample liquid so that the droplet to be formed has the desired particle size. For example, when the particle size of the formed droplet is smaller than the desired particle size of the droplet, the controller 8 may control the oscillator 4 so as to decrease the oscillation frequency of the oscillator 4.

Conversely, when the particle size of the formed droplet is larger than the desired particle size of the droplet, the controller 8 may control the oscillator 4 so as to increase the oscillation frequency of the oscillator 4. Moreover, the controller 8 may use another image processing method in order to determine the particle size of each droplet from the image of the droplet taken by the high-speed camera. For example, the controller 8 may binarize, i.e., digitize the image with an average value of luminance, then may perform a labeling to obtain a region on the image corresponding to each droplet. Then the controller 8 may determine the maximum width of each region as the particle size of each droplet.

In addition, a calibration droplet formation system may be configured to include multiple droplet formation apparatuses according to the embodiment so that droplets are formed at the same time from the respective droplet formation apparatuses. In this case, discharge holes of orifices attached to the respective droplet formation apparatuses may be different in diameter from one another. By configuring in this way, since the pressure the oscillation frequency can be separately adjusted for each droplet formation apparatus, the calibration droplet formation system can form droplets having various kinds of particle size at the same time. The above processings such as calculations and determinations are not limited being executed by the PC and may be executed by various kinds of processing systems. The above processings such as calculations and determinations may be performed by any one or any combinations of software, an electric circuit, a mechanical device, and the like. The software may be stored in the storage, and may be transmitted via a transmission device such as a network device.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A droplet formation apparatus for calibrating a particle size measurement apparatus, the droplet formation apparatus comprising:
a vessel for storing sample liquid;
a pressure unit for applying predetermined pressure to the sample liquid in the vessel;
an oscillator provided to one surface of the vessel for applying oscillation, which has a predetermined frequency, to the sample liquid in the vessel; and
an orifice provided to an other surface of the vessel,
wherein the orifice has at least one discharge hole, and
the orifice is configured to form a droplet, which has a predetermined particle size, from the sample liquid and configured to discharge the droplet in accordance with the predetermined pressure and the predetermined frequency applied to the sample liquid in the vessel.

2. The droplet formation apparatus according to claim 1, wherein the at least one discharge hole has a channel length, which is approximately 10 times or less as large as a diameter of the discharge hole.

3. The droplet formation apparatus according to claim 1, wherein the at least one discharge hole includes a plurality of discharge holes.

4. The droplet formation apparatus according to claim 3, wherein the plurality of discharge holes are different in diameter from one another.

5. The droplet formation apparatus according to claims 1, wherein the oscillator is opposed to the orifice and configured to apply the oscillation to the orifice substantially in parallel with a channel of the discharge hole.

6. The droplet formation apparatus according to claim 1,
wherein the oscillator is configured to control the predetermined frequency of the oscillation, and
the droplet formation apparatus further comprising:
a controller configured to control the oscillator so as to increase the predetermined frequency in response to reduction in particle size of the droplet discharged from the discharge hole.

7. The droplet formation apparatus according to claim 1,
wherein the pressure unit is configured to control the predetermined pressure,
the droplet formation apparatus further comprising:
a controller configured to control the pressure unit so as to decrease the predetermined pressure in response to reduction in particle size of the droplet discharged from the discharge hole.

8. The droplet formation apparatus according to claim 1, wherein the particle size measurement apparatus is configured to irradiate laser light to the droplet of the sample liquid so as to measure a particle size of the droplet.

9. A method for forming a droplet, which is for calibrating a particle size measurement apparatus, the method comprising:
applying predetermined pressure to sample liquid stored in a vessel; and
applying oscillation, which has a predetermined frequency, to the sample liquid stored in the vessel so as to form a droplet, which has a predetermined particle size, from the sample liquid and discharge the droplet through a discharge hole, which is provided in one surface of the vessel.

10. A method for calibrating a particle size measurement apparatus, the method comprising:
applying predetermined pressure to sample liquid stored in a vessel;
applying oscillation, which has a predetermined frequency, to the sample liquid stored in the vessel so as to form a droplet, which has a predetermined particle size, from the sample liquid and discharge the droplet through a discharge hole, which is provided in one surface of the vessel;
measuring the particle size of the droplet of the sample liquid by using the particle size measurement apparatus; and
calibrating the particle size measurement apparatus such that the particle size, which is measured by using the particle size measurement apparatus, corresponds to the predetermined particle size.

11. The method according to claim 10, wherein the measuring of the particle size includes:
irradiating laser light to the droplet of the sample liquid so as to measure the particle size of the droplet.
